(19) United States
(12) Patent Application Publication
(10) Pub. No.: US 2025/0055766 A1
(43) Pub. Date: Feb. 13, 2025

(54) METHOD FOR CREATING ARTIFICIAL INTELLIGENCE SESSION, AND APPARATUS THEREFOR

(71) Applicant: Beijing Xiaomi Mobile Software Co., Ltd., Beijing (CN)

(72) Inventors: Dong CHEN, Beijing (CN); Zhibin HE, Beijing (CN)

(73) Assignee: Beijing Xiaomi Mobile Software Co., Ltd., Beijing (CN)

(21) Appl. No.: 18/723,019

(22) PCT Filed: Dec. 23, 2021
(86) PCT No.: PCT/CN2021/140978

§ 371 Date: Jun. 21, 2024

(51) Int. Cl. H04L 41/16; H04W 48/16

(52) U.S. Cl. CPC H04L 41/16; H04W 48/16

(57) ABSTRACT

Disclosed in the embodiments of the present disclosure are a method for creating an artificial intelligence (AI) session, and an apparatus therefor, which method and apparatus can be applied to the technical field of communications. The method, which is executed by a terminal device, comprises: sending an AI session establishment request to an access and mobility management function (AMF) device; and then, it being possible to receive an AI session establishment response returned by an AMF. In this way, the creation of an AI session can be realized, so as to provide conditions for a terminal device to call an AI service across domains and across layers.

### TECHNICAL FIELD

The present disclosure relates to the field of communication technology, and in particular to a method and device for creating an artificial intelligence session.

### BACKGROUND

With the continuous development of artificial intelligence (AI) technology, AI technology is increasingly being used in the communications field.

In related art, network AI applications are optimized and transformed on the traditional network architecture, which are generally plug-in applications, and there are problems with the coordination of cross-domain and cross-layer AI applications.

### SUMMARY

Embodiments of the present disclosure provide a method of creating an artificial intelligence session and a device thereof, which can realize the creation of an artificial intelligence session and provide conditions for a terminal device to invoke an AI service across domains and across layers.

According to a first aspect of embodiments of the present disclosure, there is provided a method for creating an artificial intelligence session, performed by a terminal device, including: sending an artificial intelligence AI session establishment request to an access and mobility management function AMF device; and receiving an AI session establishment response returned by the AMF.

In the present disclosure, the terminal device can send an artificial intelligence AI session creation request to the access and mobility management function AMF device, after which it can receive the AI session creation response returned by the AMF. As a result, the creation of an AI session can be realized, providing conditions for the terminal device to call AI services across domains and across layers.

According to a second aspect of embodiments of the present disclosure, there is provided a method for creating an artificial intelligence session, performed by a mobility management function AMF device, including: receiving an artificial intelligence AI session establishment request sent by a terminal device; in a case where the AI session meets a preset condition, sending a session context creation request to a session management function SMF device; receiving a session context creation response returned by the SMF; and returning an AI session establishment response to the terminal device.

In the present disclosure, the AMF device, after receiving an artificial intelligence AI session establishment request sent by the terminal device, may send a session context creation request to the session management function SMF device in a case where the AI session satisfies a preset condition, and thereafter, receive a session context creation response returned by the SMF and return an AI session establishment response to the terminal device. In this way, the creation of an AI session can be realized to provide conditions for terminal devices to call AI services across domains and across layers.

According to a third aspect of embodiments of the present disclosure, there is provided a method for creating an artificial intelligence session, performed by a session management function SMF device, including: receiving an artificial intelligence AI session context creation request sent by a mobility management function AMF device; sending a session registration request to a unified data management UDM device; receiving a session registration response returned by the UDM device; and returning a session context creation response to the AMF.

In the present disclosure, after receiving an artificial intelligence AI session context creation request sent by the mobility management function AMF device, the SMF device can send a session registration request to the unified data management UDM device, after which it can receive a session registration response returned by the UDM device, and then, it can return a session context creation response to the AMF. As a result, the creation of AI session can be realized, providing conditions for terminal devices to call AI services across domains and across layers.

According to a fourth aspect of embodiments of the present disclosure, there is provided a method for creating an artificial intelligence session, performed by a unified data management UDM device, including: receiving an artificial intelligence AI session registration request sent by a session management function SMF device; verifying the AI session; and returning a session registration response to the SMF device.

In the present disclosure, after receiving an artificial intelligence AI session registration request sent by the session management function SMF device, the UDM device can verify the AI session before returning a session registration response to the SMF device. As a result, the creation of the AI session can be realized, providing conditions for the terminal device to call the AI service across domains and across layers.

According to a fifth aspect of embodiments of the present disclosure, there is provided a communication device, which is at a terminal device side, including:
a transceiver module, configured to send an artificial intelligence AI session establishment request to an access and mobility management function AMF device;
the transceiver module is configured to receive an AI session establishment response returned by the AMF.

According to a sixth aspect of embodiments of the present disclosure, there is provided a communication device, which is at a mobility management function AMF device side, including:
a transceiver module configured to receive an artificial intelligence AI session establishment request sent by a terminal device;
the transceiver module is configured to send a session context creation request to a session management function SMF device in a case where the AI session meets a preset condition;
the transceiver module is configured to receive a session context creation response returned by the SMF; and
the transceiver module is configured to return an AI session establishment response to the terminal device.

According to a seventh aspect of embodiments of the present disclosure, there is provided a communication device, which is at a session management function SMF device side, including:
a transceiver module configured to receive an artificial intelligence AI session context creation request sent by a mobility management function AMF device;
the transceiver module is configured to send a session registration request to a unified data management UDM device;
the transceiver module is configured to receive a session registration response returned by the UDM device; and
the transceiver module is configured to return a session context creation response to the AMF.

According to an eighth aspect of embodiments of the present disclosure, there is provided a communication device, which is at a unified data management UDM device side, including:
a transceiver module configured to receive an artificial intelligence AI session registration request sent by a session management function SMF device; and
a processing module configured to verify the AI session;
the transceiver module is configured to return a session registration response to the SMF device.

According to a ninth aspect of embodiments of the present disclosure, there is provided a communication device, including a processor and a memory, where the memory stores a computer program, and the processor executes the computer program stored in the memory so that the communication device is configured to perform the method according to the first aspect.

According to a tenth aspect of embodiments of the present disclosure, there is provided a communication device, including a processor and a memory, the memory stores a computer program, and the processor executes the computer program stored in the memory so that the communication device is configured to perform the method according to the second aspect.

According to an eleventh aspect of embodiments of the present disclosure, there is provided a communication device, including a processor and a memory, the memory stores a computer program, and the processor executes the computer program stored in the memory so that the communication device is configured to perform the method according to the third aspect.

According to a twelfth aspect of embodiments of the present disclosure, there is provided a communication device, including a processor and a memory, the memory stores a computer program, and the processor executes the computer program stored in the memory so that the communication device is configured to perform the method according to the fourth aspect.

According to a thirteenth aspect of embodiments of the present disclosure, there is provided a system for creating an artificial intelligence session. The system includes the communication device according to the fifth aspect, the communication device according to the sixth aspect, the communication device according to the seventh aspect and the communication device according to the eighth aspect. Or, the system includes the communication device according to the ninth aspect, the communication device according to the tenth aspect, the communication device according to the eleventh aspect and the communication device according to the twelfth aspect.

According to a fourteenth aspect of embodiments of the present disclosure, there is provided a computer-readable storage medium, configured to store instructions for the terminal device, when the instructions are performed, the terminal device is configured to perform the method according to the first aspect mentioned above.

According to a fifteenth aspect of embodiments of the present disclosure, there is provided a computer-readable storage medium, configured to store instructions for the network device, when the instructions are performed, the network device is configured to perform the method according to the second aspect mentioned above.

According to a sixteenth aspect of embodiments of the present disclosure, there is provided a computer-readable storage medium, configured to store instructions for the network device, when the instructions are performed, the network device is configured to perform the method according to the third aspect mentioned above.

According to a seventeenth aspect of embodiments of the present disclosure, there is provided a computer-readable storage medium, configured to store instructions for the network device, when the instructions are performed, the network device is configured to perform the method according to the fourth aspect mentioned above.

### BRIEF DESCRIPTION OF THE DRAWINGS

In order to more clearly illustrate the technical solutions in the embodiments of the present disclosure or the background technology, the drawings required for use in the embodiments of the present disclosure or the background technology will be described below.

FIG. 1 is a schematic diagram of an architecture of a communication system provided in the embodiments of the present disclosure;

FIG. 2 is a flow diagram of a method for creating an artificial intelligence session provided in the embodiments of the present disclosure;

FIG. 3 is a flow diagram of another method for creating an artificial intelligence session provided in the embodiments of the present disclosure;

FIG. 4 is a flow diagram of another method for creating an artificial intelligence session provided in the embodiments of the present disclosure;

FIG. 5 is a flow diagram of another method for creating an artificial intelligence session provided in the embodiments of the present disclosure;

FIG. 6 is a flow diagram of another method for creating an artificial intelligence session provided in the embodiments of the present disclosure;

FIG. 7 is a flow diagram of another method for creating an artificial intelligence session provided in the embodiments of the present disclosure;

FIG. 8 is a flow diagram of another method for creating an artificial intelligence session provided in the embodiments of the present disclosure;

FIG. 9 is a schematic diagram of a structure of a communication device provided in the embodiments of the present disclosure;

FIG. 10 is a schematic diagram of a structure of another communication device provided in the embodiments of the present disclosure;

FIG. 11 is a schematic diagram of a structure of a chip provided in the embodiments of the present disclosure.

### DETAILED DESCRIPTION

Here, the exemplary embodiments will be described in detail, and examples thereof are shown in the accompanying drawings. When the following description refers to the drawings, unless otherwise indicated, the same numbers in different drawings represent the same or similar elements. The implementation methods described in the following exemplary embodiments do not represent all implementation methods consistent with the present disclosure. Instead, they are only examples of devices and methods consistent with some aspects of the present disclosure as detailed in the attached claims.

For ease of understanding, the terms involved in the present disclosure are first introduced.

### 1. Access and Mobility Management Function (AMF)

AMF serves as the control plane access point between the terminal and wireless core network. AMF receives all connection and session related information from the user equipment, and performs registration, connection, reachability, and mobility management. In addition, AMF provides a session management message transmission channel for terminal devices and session management function (SMF) devices, and provides authentication and authorization functions for user access.

### 2. Session Management Function (SMF)

SMF is responsible for tunnel maintenance, Internet protocol (IP) address allocation and management, policy implementation and quality of service (QoS) control, billing data collection, roaming, etc.

### 3. Unified Data Management (UDM)

UDM is responsible for authentication and key agreement (AKA), user identification, access authorization, registration, mobility, subscription, SMS management, etc.

Please refer to FIG. 1, which is a schematic diagram of an architecture of a communication system provided in an embodiment of the present disclosure. The communication system may include but is not limited to a network device and a terminal device. The number and form of devices shown in FIG. 1 are only used for example and do not constitute a limitation on the embodiment of the present disclosure. In actual applications, two or more network devices and two or more terminal devices may be included. The communication system shown in FIG. 1 may include a network device 11, a terminal device 12, and an AI network device 13.

It should be noted that the technical solution of the embodiment of the present disclosure can be applied to various communication systems. For example, the technical solution of the embodiment of the present disclosure can be applied to long term evolution (LTE) system, fifth generation (5G) mobile communication system, 5G new radio (NR) system, or other future new mobile communication systems.

The network device 11 in the embodiment of the present disclosure is an entity on the network side for transmitting or receiving signals. For example, the network device 11 can be an evolved NodeB (eNB), a transmission reception point (TRP), a next generation NodeB (gNB) in the NR system, a base station in other future mobile communication systems, or an access node in a wireless fidelity (WiFi) system. The embodiment of the present disclosure does not limit the specific technology and specific device form adopted by the network device. The network device provided in the embodiment of the present disclosure can include a central unit (CU) and a distributed unit (DU), where the CU can also be called a control unit. The CU-DU structure can be configured to split the protocol layer of the network device, such as the base station, and the functions of some protocol layers are placed in the CU for centralized control, and the functions of the remaining part or all of the protocol layers are distributed in the DU, and the DU is centrally controlled by the CU.

The terminal device 12 in the embodiment of the present disclosure is an entity on the user side for receiving or transmitting signals, such as a mobile phone. The terminal device can also be called a terminal device (terminal), user equipment (UE), mobile station (MS), mobile terminal (MT), etc. The terminal device can be a car with communication function, a smart car, a mobile phone, a wearable device, a Pad, a computer with wireless transceiver function, a virtual reality (VR) terminal device, an augmented reality (AR) terminal device, a wireless terminal device in industrial control (industrial control), a wireless terminal device in self-driving, a wireless terminal device in remote medical surgery, a wireless terminal device in smart grid, a wireless terminal device in transportation safety, a wireless terminal device in smart city, a wireless terminal device in smart home, etc. The embodiment of the present disclosure does not limit the specific technology and specific device form adopted by the terminal device.

It is understandable that the communication system described in the embodiment of the present disclosure is to more clearly illustrate the technical solution of the embodiment of the present disclosure, and does not constitute a limitation on the technical solution provided by the embodiment of the present disclosure. It is known to those skilled in the art that with the evolution of the system architecture and the emergence of new business scenarios, the technical solution provided by the embodiment of the present disclosure is also applicable to similar technical problems.

In the present disclosure, in order to solve the problem of the difficulty of cross-domain and cross-layer AI application collaboration, each AI service is deployed as an independent network function (NF) on the AI network device in the core network architecture, and the configuration information of this AI service is stored in the network repository function (NRF). Thus, the terminal device can realize the collaboration of cross-domain and cross-layer AI applications by calling the AI service provided in the core network architecture. However, when the terminal device calls an AI service, it needs to first establish a connection with the AI network device that can provide the AI service. Therefore, it is necessary to provide an AI session creation method so that the terminal device can establish a connection with the AI network device, and thus the terminal device can obtain the AI service. The following is a detailed introduction to a method and device for creating an artificial intelligence session provided by the present disclosure in conjunction with the accompanying drawings.

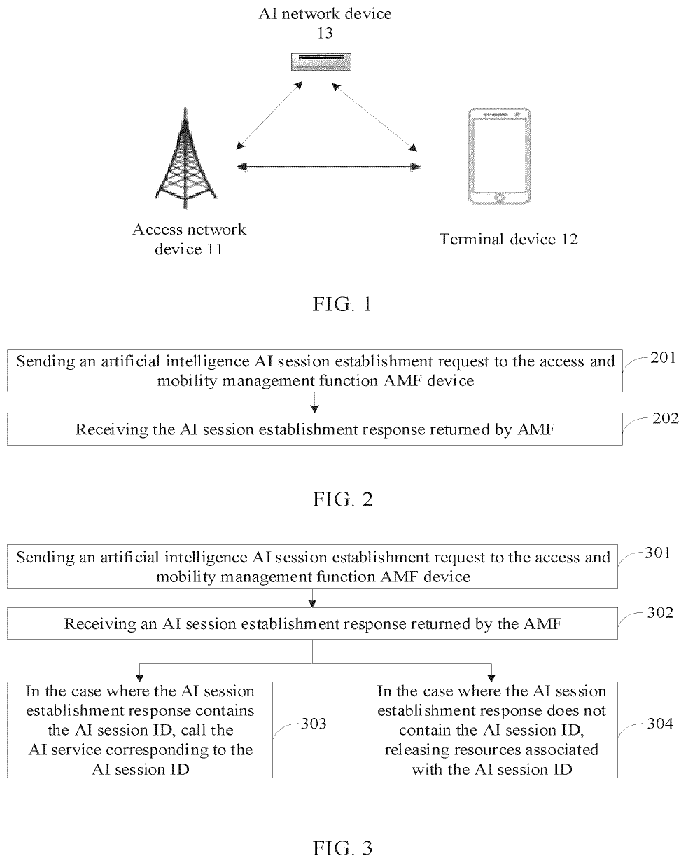

Please refer to FIG. 2, which is a flow chart of a method for creating an artificial intelligence session provided by an embodiment of the present disclosure, and the method is performed by a terminal device. As shown in FIG. 2, the method may include but is not limited to the following steps:

Step 201, sending an artificial intelligence AI session establishment request to the access and mobility management function AMF device.

The AI session establishment request may include an AI session identification ID, a request type, and AI attribute information, etc., which are not limited by the present disclosure.

In the present disclosure, the AI session ID can be any information that can uniquely identify the AI session. For example, it can be an AI session number generated by the terminal device based on the type or identification of the AI service to be called and the identification of the terminal device itself, etc., which are not limited by the present disclosure.

The AI attribute information may include the name, priority, feature words, etc. corresponding to the requested AI service, which can uniquely identify an AI service, and the present disclosure is not limited to this.

The request type can be the operation type corresponding to the session, such as: modifying a session, creating a session, deleting a session, etc. It can be understood that the request type in the AI session establishment request is creating a session.

In the present disclosure, when a terminal device requests any AI service, the terminal device can randomly generate an AI session ID, and then generate an AI session establishment request based on the AI session ID, the request type, and the AI attribute information corresponding to the requested AI service, and send the request to the AMF device.

Step 202, receiving the AI session establishment response returned by AMF.

In the present disclosure, in order to prevent the terminal device from remaining in the state of requesting AI session establishment, AMF can return an AI session establishment response to the terminal device to indicate whether the AI session establishment request is successful.

In the present disclosure, the AMF device can receive a session context creation response returned by the SMF device, and determine the AI session establishment response according to the session context creation response. For example, in the case where the session context creation response does not contain the AI session ID, the resource associated with the AI session ID can be released, and an AI session establishment response that does not contain the AI session ID can be generated. If the session context creation response contains the AI session ID, an AI session establishment response containing the AI session ID can be generated. Then, the AI session establishment response can be returned to the terminal device.

In the present disclosure, the terminal device can send an artificial intelligence AI session establishment request to the access and mobility management function AMF device, and then receive an AI session establishment response returned by the AMF. In this way, the creation of an AI session can be realized, providing conditions for the terminal device to call AI services across domains and across layers.

Please refer to FIG. 3, which is a flow chart of a method for creating an artificial intelligence session provided by an embodiment of the present disclosure, and the method is performed by the terminal device. As shown in FIG. 3, the method may include but is not limited to the following steps:

Step 301, sending an artificial intelligence AI session establishment request to the access and mobility management function AMF device.

Step 302, receiving an AI session establishment response returned by the AMF.

Step 303, in the case where the AI session establishment response contains the AI session ID, call the AI service corresponding to the AI session ID.

In the present disclosure, after receiving the AI session establishment response returned by the AMF, the terminal device can determine whether the AI session establishment response contains the AI session ID. In the case where the AI session establishment response contains the AI session ID, the terminal device can determine the AI session related configuration information according to the AI session ID, and create the corresponding session, and then call the AI service corresponding to the AI session ID.

Step 304, in the case where the AI session establishment response does not contain the AI session ID, releasing a resource associated with the AI session ID.

In the present disclosure, after receiving the AI session establishment response returned by the AMF, the terminal device can determine whether the AI session establishment response includes the AI session ID. In the case where the AI session establishment response does not include the AI session ID, it can be determined that the AI session establishment fails. Thus, the terminal device can release the resource associated with the AI session ID and end the AI session establishment request.

In the present disclosure, after the terminal device sends an artificial intelligence AI session establishment request to the access and mobility management function AMF device, it can receive the AI session establishment response returned by the AMF. Afterwards, in the case where the AI session establishment response includes the AI session ID, the AI service corresponding to the AI session ID can be called. In the case where the AI session establishment response does not include the AI session ID, the resource associated with the AI session ID can be released. Thus, while realizing the creation of the AI session, a resource can be released in time, thereby avoiding resource waste.

Please refer to FIG. 4, which is a flow chart of a method for creating an artificial intelligence session provided in an embodiment of the present disclosure, and the method is performed by the mobility management function AMF device. As shown in FIG. 4, the method may include but is not limited to the following steps:

Step 401, receiving an artificial intelligence AI session establishment request sent by a terminal device.

The AI session establishment request may include an AI session identification ID, a request type, and AI attribute information, etc., which are not limited in the present disclosure.

In the present disclosure, the AI session ID may be any information that can uniquely identify the AI session. For example, it may be an AI session number generated by the terminal device based on the type or identification of the AI service to be called and the identification of the terminal device itself, etc., which are not limited in the present disclosure.

The AI attribute information may include name, priority, and feature words corresponding to the requested AI service, which can uniquely identify an AI service, etc., and which are not limited in the present disclosure.

The request type may be the operation type corresponding to the session, such as: modifying a session, creating a session, deleting a session, etc. It can be understood that the request type in the AI session establishment request is creating a session.

In the present disclosure, when the terminal device requests any AI service, the terminal device may randomly generate an AI session ID, and then, based on the AI session ID, the request type, and the AI attribute information corresponding to the requested AI service, an AI session establishment request may be generated, and the request may be sent to the AMF device.

Step 402, in the case where the AI session meets a preset condition, a session context creation request is sent to the session management function SMF device.

The session context creation request may include the permanent identification of the subscriber, the AMF identification, the AI session ID, the request type and the AI attribute information, etc., which is not limited in the present disclosure.

In the present disclosure, the AMF identification can be any information that can uniquely identify the AMF, such as the AMF number. The permanent identification of the subscriber is any identification that can be configured to identify the terminal device. In addition, the session context creation request includes the same information as the AI session ID, the request type and the AI attribute information contained in the AI session establishment request.

In the present disclosure, the preset condition can be agreed upon by the protocol or pre-set in the system, which is not limited in the present disclosure.

In some embodiments, when the AI session does not meet the preset condition, the AI session establishment request failure message can be sent to the terminal device, so that after the terminal device receives the AI session establishment request failure message, it can release the resource associated with the AI session ID and end the AI session establishment request.

Step 403, receiving the session context creation response returned by the SMF.

In the present disclosure, the SMF device can determine the session context creation response according to the UDM session registration result, and return the session context creation response to the AMF device to indicate whether the session registration is successful. For example, when the session registration is successful, the AI session ID corresponding to the session registration response can be configured in the session context creation response. When the session registration fails, the AI session ID corresponding to the session registration response can be not configured in the session context creation response, and the resource associated with the AI session ID can be released. After that, the SMF device can return the session context creation response to the AMF.

Step 404, returning the AI session establishment response to the terminal device.

In the present disclosure, in order to prevent the terminal device from remaining in the state of requesting AI session establishment, the AMF can return the AI session establishment response to the terminal device to indicate whether the AI session establishment request is successful.

In the present disclosure, the AMF device can receive the session context creation response returned by the SMF device, and determine the AI session establishment response according to the session context creation response. In the case where the session context creation response does not contain the AI session ID, the resource associated with the AI session ID can be released, and an AI session establishment response that does not contain this AI session ID can be generated. In the case where the session context creation response contains the AI session ID, an AI session establishment response that contains this AI session ID can be generated. Then, the AI session establishment response can be returned to the terminal device.

In the present disclosure, after receiving the AI session establishment request sent by the terminal device, the AMF device can send a session context creation request to the session management function SMF device in the case where the AI session meets the preset condition, and then receive the session context creation response returned by the SMF, and return the AI session establishment response to the terminal device. In this way, the creation of the AI session can be realized, providing conditions for the terminal device to call AI services across domains and across layers.

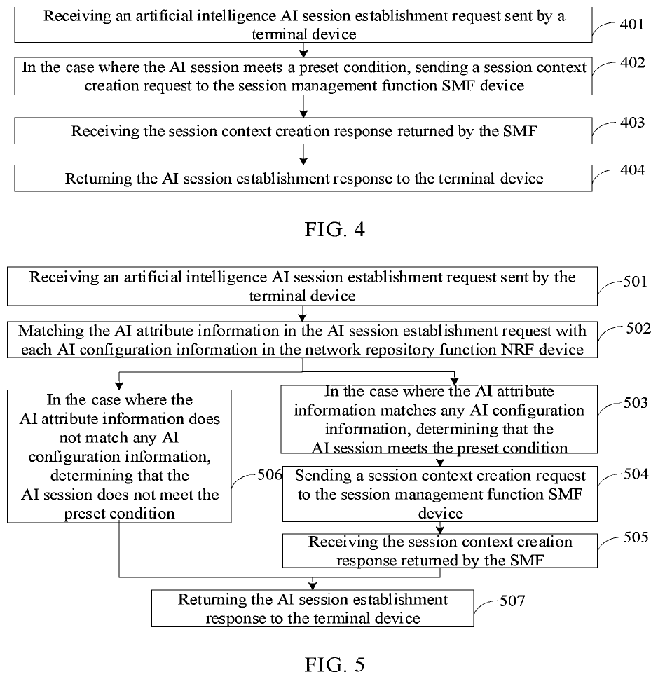

Please refer to FIG. 5, which is a flow chart of a method for creating an artificial intelligence session provided in an embodiment of the present disclosure, and the method is performed by the mobility management function AMF device. As shown in FIG. 5, the method may include but is not limited to the following steps:

Step 501, receiving an artificial intelligence AI session establishment request sent by the terminal device.

In the present disclosure, the specific implementation process of step 501 can refer to the detailed description of any embodiment in the present disclosure, and will not be repeated here.

Step 502, matching the AI attribute information in the AI session establishment request with the AI configuration information in the network repository function NRF device.

In the present disclosure, the configuration information of all AI services deployed in the AI network device can be stored in the network repository function NRF device in advance, so that the AMF device can match the AI attribute information in the AI session establishment request with the AI configuration information in the network repository function NRF device to determine whether the AI network device has deployed the AI service requested by the AI session.

Step 503, in the case where the AI attribute information matches any AI configuration information, determining that the AI session meets the preset condition.

In the present disclosure, when the AI attribute information matches any AI configuration information, it can be determined that the AI network device has deployed the AI service requested by the AI session, so that the AI session creation can continue.

Step 504, sending a session context creation request to the session management function SMF device.

Step 505, receiving the session context creation response returned by the SMF.

In the present disclosure, the specific implementation process of step 504 to step 505 can refer to the detailed description of any embodiment in the present disclosure, which will not be repeated here.

Step 506, in the case where the AI attribute information does not match any AI configuration information, determining that the AI session does not meet the preset condition.

In the present disclosure, when the AI attribute information does not match any AI configuration information, it can be determined that the AI network device has not deployed the AI service requested by the AI session, and thus the AI session creation can be terminated.

Step 507, returning the AI session establishment response to the terminal device.

In the present disclosure, the specific implementation process of step 507 can refer to the detailed description of any embodiment in the present disclosure, which will not be repeated here.

In the present disclosure, after receiving the artificial intelligence AI session establishment request sent by the terminal device, the AMF device can match the AI attribute information in the AI session establishment request with the AI configuration information in the network repository function NRF device. In the case where the AI attribute information matches any AI configuration information, it can be determined that the AI session meets the preset condition, and a session context creation request is sent to the session management function SMF device. In the case where the AI attribute information does not match each AI configuration information, it can be determined that the AI session does not meet the preset condition, and then an AI session establishment response is returned to the terminal device. Therefore, matching the AI attribute information with each AI configuration information in the NRF device can avoid the waste of resources caused by calling the undeployed AI service, thereby improving the utilization of resources.

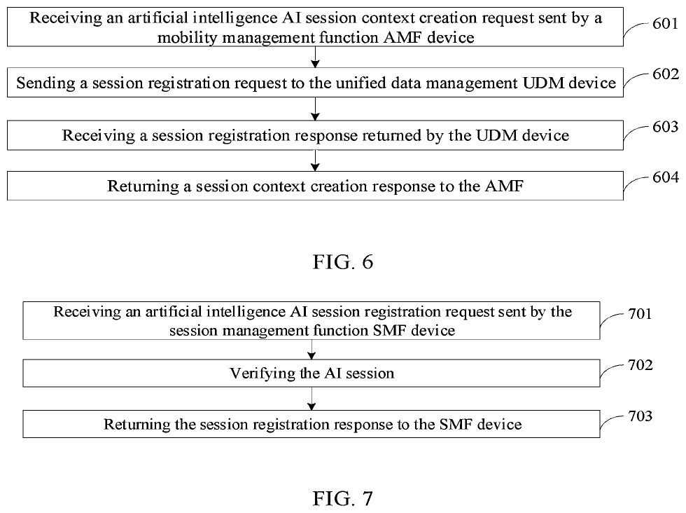

Please refer to FIG. 6, which is a flowchart of a method for creating an artificial intelligence session provided by an embodiment of the present disclosure, and the method is performed by a session management function SMF device. As shown in FIG. 6, the method may include but is not limited to the following steps:

Step 601, receiving an artificial intelligence AI session context creation request sent by a mobility management function AMF device.

The session context creation request may include a permanent identification of a subscribed user, an AMF identification, an AI session ID, a request type, and AI attribute information, etc., which are not limited in the present disclosure.

In the present disclosure, the AMF identification may be any information that can uniquely identify the AMF, such as an AMF number. The permanent identification of the subscribed user is any identification that can be configured to identify the terminal device.

The AI session ID may be any information that can uniquely identify the AI session. For example, it may be an the AI session number generated by the terminal device based on the type or identification of the AI service to be called and the identification of the terminal device itself, etc., which are not limited in the present disclosure.

The AI attribute information may include name, priority, feature words, etc. corresponding to the requested AI service, which can uniquely identify an AI service, which are not limited in the present disclosure.

The request type may be the operation type corresponding to the session, such as: modifying the session, creating the session, deleting the session, etc. It can be understood that the request type in the AI session establishment request is creating the session.

Step 602, sending a session registration request to the unified data management UDM device.

The session registration request may include information such as the permanent identification of the subscriber, the AMF identification, the AI session ID, the request type, and the AI attribute information, etc., which is not limited in the present disclosure.

In the present disclosure, the session registration request includes the same information as the permanent identification of the subscriber, the AMF identification, the AI session ID, the request type, and the AI attribute information included in the AI session context creation request.

Step 603, receiving a session registration response returned by the UDM device.

In the present disclosure, after verifying the AI session, the UDM device can return the corresponding session registration response to the SMF device. The session registration response can include the corresponding AI session ID, the registration result, etc.

In the present disclosure, after receiving the session registration response returned by the UDM device, the SMF device can determine the session context creation response according to the session registration response. For example, when the session registration response is a session registration success response, the AI session ID corresponding to the session registration response can be configured in the session context creation response. When the session registration response is a session registration failure response, the AI session ID corresponding to the session registration response cannot be configured in the session context creation response, and the resource associated with the AI session ID can be released.

Step 604, returning a session context creation response to the AMF.

In the present disclosure, after receiving the session context creation response returned by the SMF device, the AMF device can determine the AI session ID information according to the session context creation response. For example, in the case where the session context creation response does not contain the AI session ID, the resource associated with the AI session ID can be released, and an AI session establishment response that does not contain the AI session ID can be generated. In the case where the session context creation response contains the AI session ID, an AI session establishment response that contains the AI session ID can be generated. Then, the AI session establishment response can be returned to the terminal device.

In the present disclosure, after the SMF device receives the artificial intelligence AI session context creation request sent by the mobility management function AMF device, it can send a session registration request to the unified data management UDM device, and then receive the session registration response returned by the UDM device, and then return the session context creation response to the AMF. In this way, the creation of an AI session can be achieved, providing conditions for the terminal device to call AI services across domains and across layers.

Please refer to FIG. 7, which is a flow diagram of a method for creating an artificial intelligence session provided in an embodiment of the present disclosure, and the method is performed by the unified data management UDM device. As shown in FIG. 7, the method may include but is not limited to the following steps:

Step 701, receiving an artificial intelligence AI session registration request sent by the session management function SMF device.

The session registration request may include information such as the permanent identification of the subscriber, the AMF identification, the AI session ID, the request type, and the AI attribute information, etc., which is limited in the present disclosure.

The AI session ID may be any information that can uniquely identify the AI session. For example, it may be an AI session number generated by the terminal device based on the type or identification of the AI service to be called and the identification of the terminal device itself, etc., which is not limited in the present disclosure.

The AI attribute information may include the name, priority, feature words corresponding to the requested AI service, etc., which can uniquely identify an AI service, which is not limited in the present disclosure.

The request type may be the operation type corresponding to the session, such as: modifying the session, creating the session, deleting the session, etc. It can be understood that the request type in the AI session establishment request is creating the session. Step 702, verifying the AI session.

In the present disclosure, the AI service deployed on the AI network device may not be able to provide services due to authorization or function upgrades, etc. Therefore, after receiving the AI session registration request sent by the SMF device, the UDM device can verify the AI session to determine whether the AI network device supports the AI service requested by the AI session.

In the present disclosure, the UDM device can determine the AI service corresponding to the AI session according to the AI attribute information in the AI session registration request, and then match the AI service with the service list supported by the AI network device and the service list prohibited by the AI network device respectively, so as to determine whether the AI network device supports the AI service requested by the AI session. When the AI service corresponding to the AI session is in the service list supported by the AI network device, it can be determined that the AI network device supports this AI service, and the AI session can be registered at this time. When the AI service corresponding to the AI session is in the service list prohibited by the AI network device, it can be determined that the AI network device does not support this AI service, and the AI session registration can be omitted at this time.

Step 703, returning the session registration response to the SMF device.

In the present disclosure, after verifying the AI session, the UDM device can return the corresponding session registration response to the SMF device. The session registration response can include the corresponding AI session ID, registration result and other information.

In the present disclosure, in the case where the UDM device determines that the AI service corresponding to the AI session is any service in the service list supported by the AI network device, the UDM device can return a session registration success response to the SMF device. In the case where the AI service corresponding to the AI session is any service in the service list prohibited by the AI network device, the UDM device can return a session registration failure response to the SMF device and release the resource associated with the AI session ID.

In some embodiments, any bit in the session registration response can also be configured to identify whether the session registration is successful. For example, when the session registration is successful, the bit value can be set to 1, and when the session registration fails, the bit value can be set to 0.

In the present disclosure, after receiving the artificial intelligence AI session registration request sent by the session management function SMF device, the UDM device can verify the AI session and then return the session registration response to the SMF device. In this way, the creation of the AI session can be realized, providing conditions for the terminal device to call the AI service across domains and across layers.

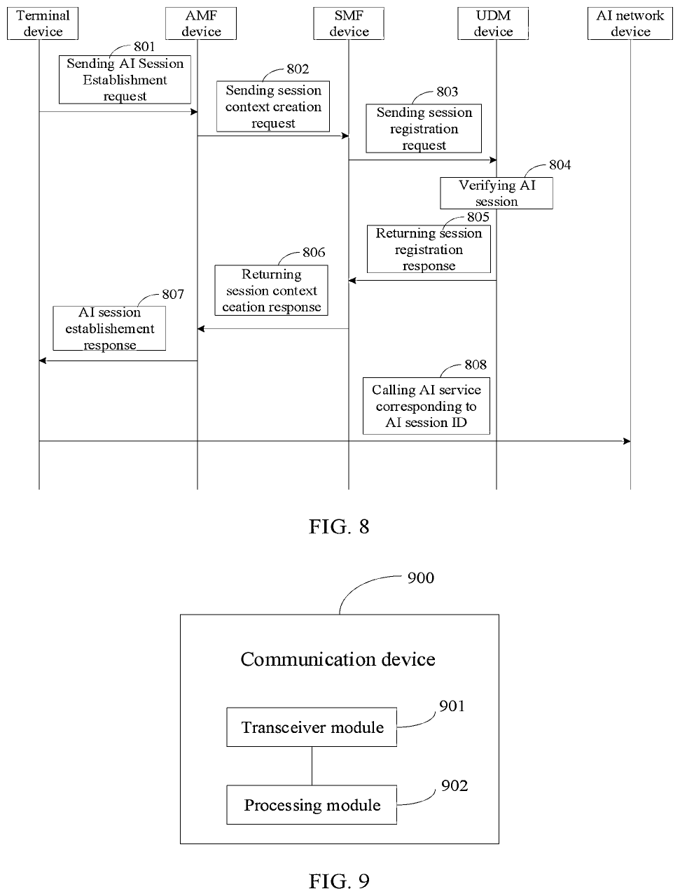

Please refer to FIG. 8, which is a flow chart of a method for creating an artificial intelligence session provided in an embodiment of the present disclosure. As shown in FIG. 8, the method may include but is not limited to the following steps:

Step 801, the terminal device sends an artificial intelligence AI session establishment request to the access and mobility management function AMF device.

The AI session establishment request may include an AI session identification ID, a request type, and AI attribute information, etc., which are not limited in the present disclosure.

In the present disclosure, the AI session ID may be any information that can uniquely identify the AI session. For example, it may be an AI session number generated by the terminal device based on the type or identification of the AI service to be called and the identification of the terminal device itself, etc., which are not limited in the present disclosure.

The AI attribute information may include the name, priority, and feature words corresponding to the requested AI service, which can uniquely identify an AI service, etc., which are not limited in the present disclosure.

The request type may be the operation type corresponding to the session, such as: modifying the session, creating the session, deleting the session, etc. It can be understood that the request type in the AI session establishment request is creating the session.

In the present disclosure, when the terminal device requests any AI service, the terminal device may randomly generate an AI session ID, and then generate an AI session establishment request based on the AI session ID, the request type, and the AI attribute information corresponding to the requested AI service, and send the request to the AMF device.

Step 802, after receiving the artificial intelligence AI session establishment request sent by the terminal device, the AMF device sends a session context creation request to the session management function SMF device in the case where the AI session meets the preset condition.

The session context creation request may include the permanent identification of the subscriber, the AMF identification, the AI session ID, the request type and the AI attribute information, etc., which are not limited in the present disclosure.

In the present disclosure, the AMF identification can be any information that can uniquely identify the AMF, such as the AMF number. The permanent identification of the subscriber is any identification that can be configured to identify the terminal device. In addition, the session context creation request includes the same information as the AI session ID, the request type and the AI attribute information contained in the AI session establishment request.

In the present disclosure, the preset condition can be agreed upon by the protocol or pre-set in the system, which are not limited in the present disclosure.

In some embodiments, in the case where the AI session does not meet the preset condition, an AI session establishment request failure message can be sent to the terminal device. Therefore, after the terminal device receives the AI session establishment request failure message, it can release the resource associated with the AI session ID and end the AI session establishment request.

Step 803, after receiving the artificial intelligence AI session context creation request sent by the AMF device, the SMF device can send a session registration request to the UDM device.

The session registration request can include information such as the permanent identification of the subscriber, the AMF identification, the AI session ID, the request type, and the AI attribute information, etc., which is limited in the present disclosure.

In the present disclosure, the session registration request includes the same information as the permanent identification of the subscriber, the AMF identification, the AI session ID, the request type, and the AI attribute information, etc. included in the AI session context creation request.

Step 804, after receiving the AI session registration request sent by the SMF device, the UDM device verifies the AI session.

In the present disclosure, the AI service deployed on the AI network device may not be able to provide services due to authorization or function upgrades, etc. Therefore, after receiving the AI session registration request sent by the SMF device, the UDM device can verify the AI session to determine whether the AI network device supports the AI service requested by the AI session.

In the present disclosure, the UDM device can determine the AI service corresponding to the AI session according to the AI attribute information in the AI session registration request, and then match the AI service with the service list supported by the AI network device and the service list prohibited by the AI network device respectively, so as to determine whether the AI network device supports the AI service requested by the AI session. When the AI service corresponding to the AI session is in the service list supported by the AI network device, it can be determined that the AI network device supports this AI service, and the AI session can be registered at this time. When the AI service corresponding to the AI session is in the service list prohibited by the AI network device, it can be determined that the AI network device does not support this AI service, and the AI session registration can be omitted at this time.

Step 805, the UDM device returns a session registration response to the SMF device.

In the present disclosure, after verifying the AI session, the UDM device can return a corresponding session registration response to the SMF device. The session registration response can include information such as the corresponding AI session ID and registration result.

In the present disclosure, in the case where the UDM device determines that the AI service corresponding to the AI session is any service in the service list supported by the AI network device, the UDM device can return a session registration success response to the SMF device. In the case where the AI service corresponding to the AI session is any service in the service list prohibited by the AI network device, the UDM device can return a session registration failure response to the SMF device and release the resource associated with the AI session ID.

In some embodiments, any bit in the session registration response can also be configured to identify whether the session registration is successful. For example, when the session registration is successful, the bit value can be set to 1, and when the session registration fails, the bit value can be set to 0.

Step 806, after receiving the session registration response returned by the UDM device, the SMF device returns a session context creation response to the AMF device.

In the present disclosure, after receiving the session registration response returned by the UDM device, the SMF device can determine the session context creation response based on the session registration response. For example, when the session registration response is a session registration success response, the AI session ID corresponding to the session registration response can be configured in the session context creation response. When the session registration response is a session registration failure response, the AI session ID corresponding to the session registration response can be not configured in the session context creation response, and the resource associated with the AI session ID can be released.

Step 807, after receiving the session context creation response returned by SMF, AMF returns an AI session establishment response to the terminal device.

In the present disclosure, in order to prevent the terminal device from remaining in the state of requesting AI session establishment, AMF can return an AI session establishment response to the terminal device to indicate whether the AI session establishment request is successful.

In the present disclosure, the AMF device can receive the session context creation response returned by the SMF device, and determine the AI session establishment response according to the session context creation response. In the case where the session context creation response does not contain the AI session ID, the resource associated with the AI session ID can be released, and an AI session establishment response that does not contain the AI session ID can be generated. In the case where the session context creation response contains the AI session ID, an AI session establishment response containing the AI session ID can be generated. Then, the AI session establishment response can be returned to the terminal device.

Step 808, after the terminal device receives the AI session establishment response returned by AMF, in the case where the AI session establishment response contains the AI session ID, the AI service corresponding to the AI session ID is called.

In the present disclosure, after receiving the AI session establishment response returned by AMF, the terminal device can determine whether the AI session establishment response contains the AI session ID. In the case where the AI session establishment response contains the AI session ID, the terminal device can determine the AI session-related configuration information based on the AI session ID and create a corresponding session, and then call the AI service corresponding to the AI session ID. In the case where the AI session establishment response does not contain the AI session ID, it can be determined that the AI session establishment has failed. Therefore, the terminal device can release the resource associated with the AI session ID and end the AI session establishment request.

In the present disclosure, the terminal device sends an artificial intelligence AI session establishment request to the access and mobility management function AMF device. After receiving the artificial intelligence AI session establishment request sent by the terminal device, the AMF device sends a session context creation request to the session management function SMF device in the case where the AI session meets the preset condition. After receiving the artificial intelligence AI session context creation request sent by the AMF device, the SMF device can send a session registration request to the UDM device. After receiving the AI session registration request sent by the SMF device, the UDM device verifies the AI session. The UDM device returns a session registration response to the SMF device. After receiving the session registration response returned by the UDM device, the SMF device returns a session context creation response to the AMF device. After receiving the session context creation response returned by the SMF, the AMF returns an AI session establishment response to the terminal device. After receiving the AI session establishment response returned by the AMF, the terminal device calls the AI service corresponding to the AI session ID in the case where the AI session establishment response contains the AI session ID. In this way, the creation of the AI session can be realized, and conditions are provided for the terminal device to call the AI service across domains and across layers.

Please refer to FIG. 9, which is a structural schematic diagram of a communication device 900 provided in an embodiment of the present disclosure. The communication device 900 shown in FIG. 9 may include a transceiver module 901 and a processing module 902. The transceiver module 901 may include a sending module and/or a receiving module. The sending module is configured to implement the sending function, and the receiving module is configured to implement the receiving function. The transceiver module 901 may implement the sending function and/or the receiving function.

It can be understood that the communication device 900 may be a terminal device, or a device in a terminal device, or a device that can be used in conjunction with a terminal device.

The communication device 900 is on the terminal device side, wherein:
the transceiver module 901 is configured to send an artificial intelligence AI session establishment request to the access and mobility management function AMF device; and
the above-mentioned transceiver module 901 is configured to receive the AI session establishment response returned by the AMF.

In some embodiments, the AI session establishment request includes at least one of the following information:
AI session identification ID, request type and AI attribute information.

In some embodiments, the communication device further includes:
a processing module 902, configured to call the AI service corresponding to the AI session ID in the case where the AI session establishment response includes the AI session ID;
or, release the resource associated with the AI session ID in the case where the AI session establishment response does not include the AI session ID.

It can be understood that the communication device 900 can be a mobility management function AMF device, or a device in the mobility management function AMF device, or a device that can be used in combination with the mobility management function AMF device.

The communication device 900 is on the mobility management function AMF device side, wherein:
the transceiver module 901 is configured to receive an artificial intelligence AI session establishment request sent by a terminal device;
the transceiver module 901 is configured to send a session context creation request to the session management function SMF device in the case where the AI session meets the preset condition;
the transceiver module 901 is configured to receive the session context creation response returned by the SMF; and
the transceiver module 901 is configured to return the AI session establishment response to the terminal device.

In some embodiments, the communication device further includes:
a processing module 902, configured to match the AI attribute information in the AI session establishment request with each AI configuration information in the network repository function NRF device.

The processing module 902 is configured to determine that the AI session meets the preset condition in the case where the AI attribute information matches any AI configuration information.

The processing module 902 is configured to determine that the AI session does not meet the preset condition in the case where the AI attribute information does not match any AI configuration information.

In some embodiments, the AI session establishment request includes at least one of the following information:
AI session identification ID, request type and AI attribute information.

In some embodiments, the session context creation request includes at least one of the following information:
the permanent identification of the subscriber, the AMF identification, the AI session ID, the request type and the AI attribute information.

In some embodiments, the processing module 902 is also configured to:
release the resource associated with the AI session ID in the case where the session context creation response does not include the AI session ID.

It can be understood that the communication device 900 can be a session management function SMF device, or a device in the SMF device, or a device that can be used with the SMF device.

The communication device 900 is on the SMF device side, wherein:
the transceiver module 901 is configured to receive an artificial intelligence AI session context creation request sent by a mobility management function AMF device;
the transceiver module 901 is configured to send a session registration request to a unified data management UDM device;
the transceiver module 901 is configured to receive a session registration response returned by the UDM device; and
the transceiver module 901 is configured to return a session context creation response to the AMF.

In some embodiments, the session context creation request includes at least one of the following information:

The permanent identification of the subscriber, the AMF identification, the AI session ID, the request type, and the AI attribute information.

It can be understood that the communication device 900 can be a unified data management UDM device, or a device in the UDM device, or a device that can be used with the UDM device.

The communication device 900 is on the UDM device side, wherein:
the transceiver module 901 is configured to receive an artificial intelligence AI session registration request sent by a session management function SMF device;
the processing module 902 is configured to verify the AI session; and
the transceiver module 901 is configured to return a session registration response to the SMF device.

In some embodiments, the processing module 902 is specifically configured to:
determine the service corresponding to the AI session according to the AI attribute information in the AI session registration request; and
match the service corresponding to the AI session with the service list supported by the AI network device and the service list prohibited by the AI network device respectively.

In some embodiments, the transceiver module 901 is specifically configured to:
return a session registration success response to the SMF device in the case where the service corresponding to the AI session is any service in the service list supported by the AI network device;
or, return a session registration failure response to the SMF device in the case where the service corresponding to the AI session is any service in the service list prohibited by the AI network device.

In the present disclosure, the terminal device can send an artificial intelligence AI session establishment request to the access and mobility management function AMF device, and then receive the AI session establishment response returned by the AMF. Thus, the creation of AI session can be realized, and conditions are provided for the terminal device to call AI service across domains and across layers.

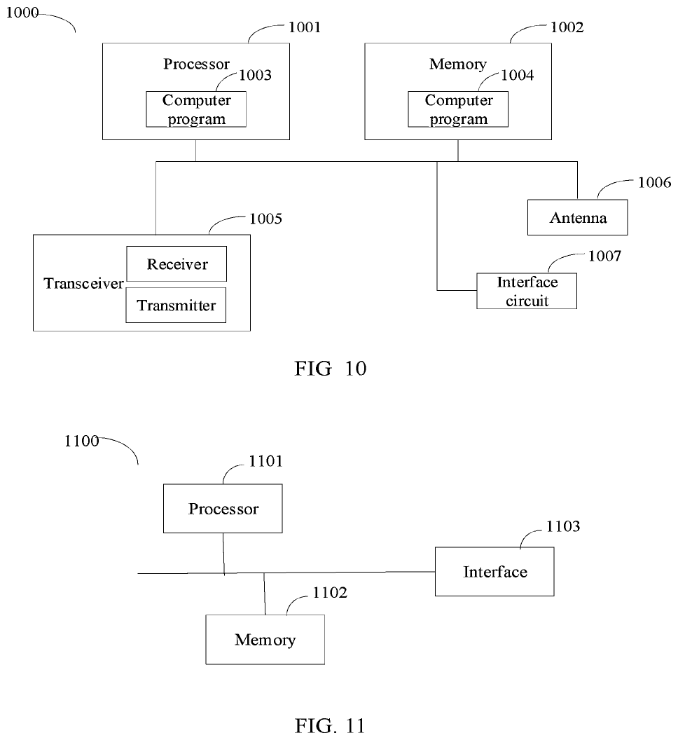

Please refer to FIG. 10, which is a structural schematic diagram of another communication device 900 provided in an embodiment of the present disclosure. The communication device 1000 can be a network device, or a terminal device, or a chip, chip system, or processor that supports the network device to implement the above method, or a chip, chip system, or processor that supports the terminal device to implement the above method. The device can be configured to implement the method described in the above method embodiment, and the details can be referred to the description in the above method embodiment.

The communication device 1000 may include one or more processors 1001. The processor 1001 may be a general-purpose processor or a dedicated processor. For example, it may be a baseband processor or a central processing unit. The baseband processor can be configured to process the communication protocol and the communication data, and the central processing unit can be configured to control the communication device (such as a base station, a baseband chip, a terminal device, a terminal device chip, a DU or a CU, etc.), execute a computer program, and process the data of the computer program.

In some embodiments, the communication device 1000 may also include one or more memories 1002, on which a computer program 1004 may be stored, and the processor 1001 executes the computer program 1004 so that the communication device 1000 executes the method described in the above method embodiment. In some embodiments, data may also be stored in the memory 1002. The communication device 1000 and the memory 1002 may be provided separately or integrated together.

In some embodiments, the communication device 1000 may also include a transceiver 1005 and an antenna 1006. The transceiver 1005 may be referred to as a transceiver unit, a transceiver, or a transceiver circuit, etc., for implementing transmitting and receiving function. The transceiver 1005 may include a receiver and a transmitter. The receiver may be referred to as a receiver or a receiving circuit, etc., for implementing a receiving function. The transmitter may be referred to as a transmitter or a transmitting circuit, etc., for implementing a transmitting function.

In some embodiments, the communication device 1000 may also include one or more interface circuits 1007. The interface circuit 1007 is configured to receive code instructions and transmit them to the processor 1001. The processor 1001 runs the code instructions to enable the communication device 1000 to execute the method described in the above method embodiment.

The communication device 1000 is a terminal device: the processor 1001 is configured to execute step 304 in FIG. 3, etc.

The communication device 1000 is an AMF device: the transceiver 1005 is configured to execute steps 401, 402, and 403 in FIG. 4; steps 501 and 503 in FIG. 5, etc.

The communication device 1000 is an SMF device: the transceiver 1005 is configured to execute steps 601, 602, 603, and 604 in FIG. 6, etc.

The communication device 1000 is a UDM device: the transceiver 1005 is configured to execute steps 701 and 703 in FIG. 7, etc.

In one implementation, the processor 1001 may include a transceiver for implementing receiving and transmitting functions. For example, the transceiver may be a transceiver circuit, an interface, or an interface circuit. The transceiver circuit, interface, or interface circuit for implementing receiving and transmitting functions may be separate or integrated. The above-mentioned transceiver circuit, interface or interface circuit can be configured to read and write code/data, or the above-mentioned transceiver circuit, interface or interface circuit can be configured for signal transmission or delivery.

In one implementation, the processor 1001 can store a computer program 1003, and the computer program 1003 runs on the processor 1001, which can enable the communication device 1000 to perform the method described in the above method embodiment. The computer program 1003 may be fixed in the processor 1001, in which case the processor 1001 may be implemented by hardware.

In one implementation, the communication device 1000 may include a circuit, which can implement the functions of sending or receiving or communicating in the above method embodiment. The processor and transceiver described in the present disclosure can be implemented on an integrated circuit (IC), an analog IC, a radio frequency integrated circuit RFIC, a mixed signal IC, an application specific integrated circuit (ASIC), a printed circuit board (PCB), an electronic device, etc. The processor and transceiver can also be manufactured using various IC process technologies, such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon germanium (SiGe), gallium arsenide (GaAs), etc.

The communication device described in the above embodiments may be a network device or an access network device (such as the terminal device in the aforementioned method embodiment), but the scope of the communication device described in the present disclosure is not limited thereto, and the structure of the communication device may not be limited to FIG. 10. The communication device may be an independent device or may be part of a larger device. For example, the communication device may be:
(1) an independent integrated circuit IC, or a chip, or a chip system or subsystem;
(2) a collection of one or more ICs, for example, the IC collection may also include a storage component for storing data or computer programs;
(3) an ASIC, such as a modem;
(4) a module that can be embedded in other devices;
(5) a receiver, a terminal device, an intelligent terminal device, a cellular phone, a wireless device, a handheld device, a mobile unit, a vehicle-mounted device, a network device, a cloud device, an artificial intelligence device, etc.;
(6) others, etc.

For the case where the communication device may be a chip or a chip system, see the structural schematic diagram of the chip shown in FIG. 11. The chip shown in FIG. 11 includes a processor 1101 and an interface 1103. The number of processors 1101 may be one or more, and the number of interfaces 1103 may be multiple.

For the case where the chip is configured to implement the functions of the terminal device in the embodiment of the present disclosure:
the interface 1103 is configured to execute steps 201 and 202 in FIG. 2; and steps 301 and 302 in FIG. 3, etc.

For the case where the chip is configured to implement the function of the AMF device in the embodiment of the present disclosure:
the interface 1103 is configured to execute steps 401, 402, and 403 in FIG. 4; and steps 501 and 503 in FIG. 5, etc.

For the case where the chip is configured to implement the function of the SMF device in the embodiment of the present disclosure:
the interface 1103 is configured to execute steps 601, 602, 603, and 604 in FIG. 6, etc.

For the case where the chip is configured to implement the function of the UDM device in the embodiment of the present disclosure:
the interface 1103 is configured to execute steps 701 and 703 in FIG. 7, etc.

In some embodiments, the chip also includes a memory 1103, which is configured to store necessary computer programs and data.

Those skilled in the art may also understand that the various illustrative logical blocks and steps listed in the embodiment of the present disclosure may be implemented by electronic hardware, computer software, or a combination of both. Whether such functions are implemented by hardware or software depends on the specific application and the design requirements of the entire system. Those skilled in the art may use various methods to implement the functions described for each specific application, but such implementation should not be understood as exceeding the scope of protection of the embodiment of the present disclosure.

The present disclosure also provides a readable storage medium on which instructions are stored, and when the instructions are performed by a computer, the functions of any of the above-mentioned method embodiments are realized.

The present disclosure also provides a computer program product, which, when performed by a computer, realizes the functions of any of the above-mentioned method embodiments.

In the above-mentioned embodiments, it can be implemented in whole or in part by software, hardware, firmware, or any combination thereof. When implemented by software, it can be implemented in whole or in part in the form of a computer program product. The computer program product includes one or more computer programs. When the computer program is loaded and performed on a computer, the process or function described in the embodiment of the present disclosure is generated in whole or in part. The computer can be a general-purpose computer, a special-purpose computer, a computer network, or other programmable device. The computer program can be stored in a computer-readable storage medium, or transmitted from one computer-readable storage medium to another computer-readable storage medium. For example, the computer program can be transmitted from one website, computer, server, or data center to another website, computer, server, or data center by wired (e.g., coaxial cable, optical fiber, digital subscriber line (DSL)) or wireless (e.g., infrared, wireless, microwave, etc.) means. The computer-readable storage medium may be any available medium that can be accessed by a computer or a data storage device such as a server or a data center that includes one or more available media. The available medium may be a magnetic medium (e.g., a floppy disk, a hard disk, a tape), an optical medium (e.g., a high-density digital video disc (DVD)), or a semiconductor medium (e.g., a solid-state disk (SSD)).

It is understood that in the present disclosure, “multiple” refers to two or more, and other quantifiers are similar. “And/or” describes the association relationship of associated objects, indicating that three relationships may exist. For example, A and/or B can represent: A exists alone, A and B exist at the same time, and B exists alone. The character “/” generally indicates that the associated objects before and after are in an “or” relationship. The singular forms of “a”, “the” and “the” are also intended to include plural forms unless the context clearly indicates other meanings.

It is further understood that although the operations are described in a specific order in the drawings in the embodiments of the present disclosure, it should not be understood as requiring the operations to be performed in the specific order or serial order shown, or requiring all the operations shown to be performed to obtain the desired results. In certain environments, multitasking and parallel processing may be advantageous.

A person skilled in the art may understand that the various digital numbers such as first and second involved in the present disclosure are only for the convenience of description, and does not intend to limit the scope of the embodiments of the present disclosure, and also indicate the order of precedence.

At least one in the present disclosure can also be described as one or more, and the multiple can be two, three, four or more, which is not limited by the present disclosure. In the embodiments of the present disclosure, for one kind of technical feature, technical features in the kind of technical feature are distinguished by “first”, “second”, “third”, “A”, “B”, “C” and “D”, etc., and there is no order of precedence or size between the technical features described by the “first”, “second”, “third”, “A”, “B”, “C” and “D”.

The correspondences shown in the tables in the present disclosure can be configured or predefined. The values of the information in the tables are only examples and can be configured as other values, which are not limited by the present disclosure. When configuring the correspondence between the information and the parameters, it is not necessarily required to configure all the correspondences illustrated in the tables. For example, in the table in the present disclosure, the correspondences shown in some rows may not be configured. For another example, appropriate deformation adjustments can be made based on the above table, such as splitting, merging, etc. The names of the parameters shown in the titles of the above tables may also be other names that can be understood by the communication device, and the values or representations of the parameters may also be other values or representations that can be understood by the communication device. When implementing the above tables, other data structures may also be used, such as arrays, queues, containers, stacks, linear lists, pointers, linked lists, trees, graphs, structures, classes, heaps, hash tables, etc.

The predefinition in the present disclosure may be understood as definition, definition in advance, storage, pre-storage, pre-negotiation, pre-configuration, curing, or pre-burning.

A person of ordinary skill in the art may realize that the units and algorithm steps of the various examples described in the embodiments disclosed herein may be implemented in electronic hardware or in a combination of computer software and electronic hardware. Whether these functions are performed in hardware or software depends on the specific application and design constraints of the technical solution. Professional technicians may use different methods to implement the described functions for each specific application, but such implementation should not be considered to be beyond the scope of the present disclosure.

A person of ordinary skill in the art may clearly understand that for the convenience and simplicity of description, the specific working process of the system, device and unit described above may refer to the corresponding process in the aforementioned method embodiment, and will not be repeated here.

After considering the specification and practicing the present disclosure herein, those skilled in the art will easily think of other embodiments of the present disclosure. This application is intended to cover any modification, use or adaptation of the present disclosure, which follows the general principles of the present disclosure and includes common knowledge or customary technical means in the technical field not disclosed in the present disclosure. The description and examples are only to be regarded as exemplary, and the true scope and spirit of the present disclosure are indicated by the following claims.

The above is only a specific implementation of the present disclosure, but the scope of protection of the present disclosure is not limited thereto. Those skilled in the art can easily think of changes or substitutions within the technical scope disclosed in the present disclosure, which should be covered within the scope of protection of the present disclosure. Therefore, the scope of protection of the present disclosure shall be subject to the scope of protection of the claims.

What is claimed is:

1. A method for creating an artificial intelligence session, performed by a terminal device, comprising:
sending an artificial intelligence AI session establishment request to an access and mobility management function AMF device; and
receiving an AI session establishment response returned by the AMF.

2. The method according to claim 1, wherein the AI session establishment request comprises at least one of the following information:
an AI session identification ID, a request type and AI attribute information.

3. The method according to claim 1, further comprising:
in a case where the AI session establishment response contains an AI session ID, calling an AI service corresponding to the AI session ID; or
in a case where the AI session establishment response does not contain an AI session ID, releasing a resource associated with the AI session ID.

4. A method for creating an artificial intelligence session, performed by a mobility management function AMF device, comprising:
receiving an artificial intelligence AI session establishment request sent by a terminal device;
in a case where the AI session meets a preset condition, sending a session context creation request to a session management function SMF device;
receiving a session context creation response returned by the SMF; and
returning an AI session establishment response to the terminal device.

5. The method according to claim 4, further comprising:
matching AI attribute information in the AI session establishment request with each AI configuration information in a network repository function NRF device;
in a case where the AI attribute information matches any AI configuration information, determining that the AI session meets the preset condition; and
in a case where the AI attribute information does not match any AI configuration information, determining that the AI session does not meet the preset condition.

6. The method according to claim 4, wherein the AI session establishment request comprises at least one of the following information:
an AI session identification ID, a request type and AI attribute information.

7. The method according to claim 4, wherein the session context creation request comprises at least one of the following information:
a permanent identification of a subscriber, an AMF identification, an AI session ID, a request type and AI attribute information.

8. The method according to any one of claims 4 to 7, further comprising:
in a case where the session context creation response does not contain an AI session ID, releasing a resource associated with the AI session ID.

9. A method for creating an artificial intelligence session, performed by a session management function SMF device, comprising:
receiving an artificial intelligence AI session context creation request sent by a mobility management function AMF device;
sending a session registration request to a unified data management UDM device;
receiving a session registration response returned by the UDM device; and
returning a session context creation response to the AMF.

10. The method according to claim 9, wherein the session context creation request comprises at least one of the following information:
a permanent identification of a subscriber, an AMF identification, an AI session ID, a request type and AI attribute information.

11. A method for creating an artificial intelligence session, performed by a unified data management UDM device, comprising:
receiving an artificial intelligence AI session registration request sent by a session management function SMF device;
verifying the AI session; and
returning a session registration response to the SMF device.

12. The method according to claim 11, wherein verifying the AI session comprises:
determining a service corresponding to the AI session according to AI attribute information in the AI session registration request; and
matching the service corresponding to the AI session with a service list supported by an AI network device and a service list prohibited by the AI network device respectively.

13. The method according to claim 12, wherein returning the session registration response to the SMF device comprises:
in a case where the service corresponding to the AI session is any service in the service list supported by the AI network device, returning a session registration success response to the SMF device; or
in a case where the service corresponding to the AI session is any service in the service list prohibited by the AI network device, returning a session registration failure response to the SMF device.

14. A communication device, comprising:
a transceiver module, configured to send an artificial intelligence AI session establishment request to an access and mobility management function AMF device;
wherein the transceiver module is configured to receive an AI session establishment response returned by the AMF.

15. The device according to claim 14, wherein the AI session establishment request comprises at least one of the following information:
an AI session identification ID, a request type and AI attribute information.

16. The device according to claim 14, wherein the communication device further comprises:
a processing module configured to call an AI service corresponding to an AI session ID in a case where the AI session establishment response contains the AI session ID; or release a resource associated with an AI session ID in a case where the AI session establishment response does not contain the AI session ID.

17. A communication device, comprising:
a transceiver module configured to receive an artificial intelligence AI session establishment request sent by a terminal device;
wherein the transceiver module is configured to send a session context creation request to a session management function SMF device in a case where the AI session meets a preset condition;
the transceiver module is configured to receive a session context creation response returned by the SMF; and
the transceiver module is configured to return an AI session establishment response to the terminal device.

18. The device according to claim 17, further comprising:
a processing module configured to match AI attribute information in the AI session establishment request with each AI configuration information in a network repository function NRF device;
wherein the processing module is configured to determine that the AI session meets a preset condition in a case where the AI attribute information matches any AI configuration information; and
the processing module is configured to determine that the AI session does not meet the preset condition in a case where the AI attribute information does not match any AI configuration information.

19. The device according to claim 17, wherein the AI session establishment request comprises at least one of the following information:
an AI session identification ID, a request type and AI attribute information.

20. The device according to claim 17, wherein the session context creation request comprises at least one of the following information:
a permanent identification of a subscriber, an AMF identification, an AI session ID, a request type and AI attribute information

21. The device according to any one of claims 17 to 20, wherein the processing module is further configured to:
release a resource associated with an AI session ID in a case where the session context creation response does not contain the AI session ID.

22. A communication device, comprising:
a transceiver module configured to receive an artificial intelligence AI session context creation request sent by a mobility management function AMF device;
wherein the transceiver module is configured to send a session registration request to a unified data management UDM device;
the transceiver module is configured to receive a session registration response returned by the UDM device; and
the transceiver module is configured to return a session context creation response to the AMF.

23. The device according to claim 22, wherein the session context creation request comprises at least one of the following information:
a permanent identification of a subscriber, an AMF identification, an AI session ID, a request type and AI attribute information.

24. A communication device, comprising:
a transceiver module configured to receive an artificial intelligence AI session registration request sent by a session management function SMF device; and
a processing module configured to verify the AI session;
wherein the transceiver module is configured to return a session registration response to the SMF device.

25. The device according to claim 24, wherein the processing module is particularly configured to:
determine a service corresponding to the AI session according to AI attribute information in the AI session registration request; and
match the service corresponding to the AI session with a service list supported by an AI network device and a service list prohibited by the AI network device respectively.

26. The device according to claim 25, wherein the transceiver module is specifically configured to:
return a session registration success response to the SMF device in a case where the service corresponding to the AI session is any service in the service list supported by the AI network device; or
return a session registration failure response to the SMF device in a case where the service corresponding to the AI session is any service in the service list prohibited by the AI network device.

27. A communication device, comprising a processor and a memory, wherein the memory stores a computer program, and the processor executes the computer program stored in the memory so that the device is configured to perform the method according to any one of claims 1 to 3.

28. A communication device, comprising a processor and a memory, the memory stores a computer program, and the processor executes the computer program stored in the memory so that the device is configured to perform the method according to any one of claims 4 to 8.

29. A communication device, comprising a processor and a memory, the memory stores a computer program, and the processor executes the computer program stored in the memory so that the device is configured to perform the method according to any one of claims 9 to 10.

30. A communication device, comprising a processor and a memory, the memory stores a computer program, and the processor executes the computer program stored in the memory so that the device is configured to perform the method according to any one of claims 11 to 13.

31. A computer-readable storage medium, configured to store instructions, when the instructions are performed, the method according to any one of claims 1 to 3 is implemented.

32. A computer-readable storage medium, configured to store instructions, when the instructions are performed, the method according to any one of claims 4 to 8 is implemented.

33. A computer-readable storage medium, configured to store instructions, when the instructions are performed, the method according to any one of claims 9 to 10 is implemented.

34. A computer-readable storage medium, configured to store instructions, when the instructions are performed, the method according to any one of claims 11 to 13 is implemented.
